(19) United States
(12) Patent Application Publication
(10) Pub. No.: US 2009/0319489 A1
(43) Pub. Date: Dec. 24, 2009

(54) System and Method for Improving Operations on a Media Server

(75) Inventors: Mika Juhani Saaranen, Pirkkala (FI); Antti Iisakki Tapiola, Kisko (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/426,070

(22) Filed: Apr. 17, 2009

Related U.S. Application Data
(60) Provisional application No. 61/045,889, filed on Apr. 17, 2008.

(51) Int. Cl. G06F 15/173; G06F 17/30

(52) U.S. Cl. 707/3; 709/226; 707/E17.014

(57) ABSTRACT

A system and method by which a media server's operations may be improved. A new action parameter is provided. The action parameter, which may be used, for example, in browse and CreateObject operations, may be used by a device as a “hint” to inform a server about a forthcoming action. This action parameter allows the media server to optimize its operations, for example by increasing the priority of server processes, scheduling maintenance operations so that they occur at a later time, etc. Information related to the action may be provided by a control point which orders multimedia actions to occur in a home network.

### RELATED APPLICATIONS

This application claims priority under 35 U.S.C. § 119(e) from U.S. Provisional Application Ser. No. 61/045,889, filed Apr. 17, 2008, incorporated herein by reference in its entirety.

### FIELD OF THE INVENTION

The present invention relates generally to Universal Plug and Play (UPnP) technology. More particularly, the present invention relates to the use of media servers in a UPnP environment.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology defines an architecture for pervasive peer-to-peer network connectivity of intelligent appliances, wireless devices, and personal computer devices of all types. UPnP is designed to bring easy-to-use, flexible, standards-based connectivity to ad-hoc or unmanaged networks whether in the home, in a small business, public spaces, or attached to the Internet. UPnP technology provides a distributed, open networking architecture that leverages Transmission Control Protocol/Internet Protocol (TCP/IP) and Web technologies in order to enable seamless proximity networking, in addition to control and data transfer among networked devices.

The UPnP Device Architecture (UDA) is designed to support zero-configuration, “invisible” networking and automatic discovery for a breadth of device categories from a wide range of vendors. In other words, UPnP enables a device to be capable of dynamically joining a network, obtaining an IP address, conveying the device's capabilities, and learning about the presence and capabilities of other devices.

A UPnP media server defines a UPnP entity that can serve multimedia for use and playing by various devices. Such a media server provides a content director, which shows which types of content can be provided by the media server.

### SUMMARY OF THE INVENTION

Various embodiments provide a system and method by which a media server's operations may be improved. In various embodiments, a new action parameter, for resource-intensive actions such as browse and CreateObject operations, is provided. This new parameter may be used as a “hint” by a control point to inform a device about a forthcoming action. This parameter allows the media server to optimize its operations, for example by increasing the priority of server processes, scheduling maintenance operations so that they occur at a later time, etc. Information related to the action may be provided by a control point which orders multimedia actions to occur in a home network.

Various embodiments provide a method, computer program product, and apparatus for improving performance-related characteristics at a server device. According to various embodiments, a message is received at a server device concerning a request made by a control point device. The message includes an indication that subsequent related requests will be made by the control point device. A first set of results is returned to the control point device in response to the request, and at least one responsive action is taken in response to the indication. The responsive one action is, at least, related to improving resource utilization at the server device at least during a period in which the subsequent related requests are expected.

Various embodiments also provide a method, computer program product, and apparatus for improving performance-related characteristics at a server device. First, it is determined that a control point device desires to make a plurality of related requests directed to a server device. In response to the determination, a message concerning a particular request is prepared. The message includes an indication that subsequent related requests will be made. The message is then transmitted to a server device, whereby the indication is usable by the server device in taking at least one responsive action in response to the indication. The at least one action is related to improving resource utilization at the server device at least during a period in which the subsequent related requests are expected.

These and other advantages and features of various embodiments of the present invention, together with the organization and manner of operation thereof, will become apparent from the following detailed description when taken in conjunction with the accompanying drawings, wherein like elements have like numerals throughout the several drawings described below. Additionally, a mechanism may be provided by which the owner of the mobile media server may be notified if a processing-intensive task is about to be commenced.

### BRIEF DESCRIPTION OF THE DRAWINGS

FIG. 1 is a message flow diagram depicting messages that are transmitted between a control point device and a media server device in a conventional browsing situation;

FIG. 2 is a message flow diagram depicting messages that are transmitted between a control point device and a media server device in a use case scenario according to various embodiments;

FIG. 3 is a message flow diagram depicting how an end user of a media server device may be informed of a sequential CreateObject operation according to various embodiments;

FIG. 4 is an overview diagram of a system within which various embodiments of the present invention may be implemented;

FIG. 5 is a perspective view of an electronic device that can be used in conjunction with the implementation of various embodiments of the present invention; and

FIG. 6 is a schematic representation of the circuitry which may be included in the electronic device of FIG. 5.

### DETAILED DESCRIPTION OF VARIOUS EMBODIMENTS

Various embodiments provide a system and method by which a media server's operations may be improved. When a media server is implemented on a device with limited resources, the commencing of resource-intensive operations on the media server can result in distorted operations and a poor overall user experience. This may be especially true in the event that the device is already processing a resource-intensive tasks when a new operation is requested.

In various embodiments, the control point which is communicating with the media server can provide a “hint” to the media server that there will be sequential operations. In response, the media server device or other receiving device can use this information to better optimize its internal operations. For example, in a case where there is structured query language (SQL)-based metadata storage implementation in the media server, there will be often be a great deal of computer processing time used for every individual SQL database “read” operation. Therefore, if the control point can hint to the media server that there will be several browsing requests in the near future, then the media server can adjust its own operations so as to delay other process during the time that subsequent requests are expected. This can result in a shorter latency period in communications between the control point and the media server and thus better a user experience. This can also result in an end user of the media service device having a better user experience, since he or she can decide to delay certain processing actions until the control point has received all of the information that it requested.

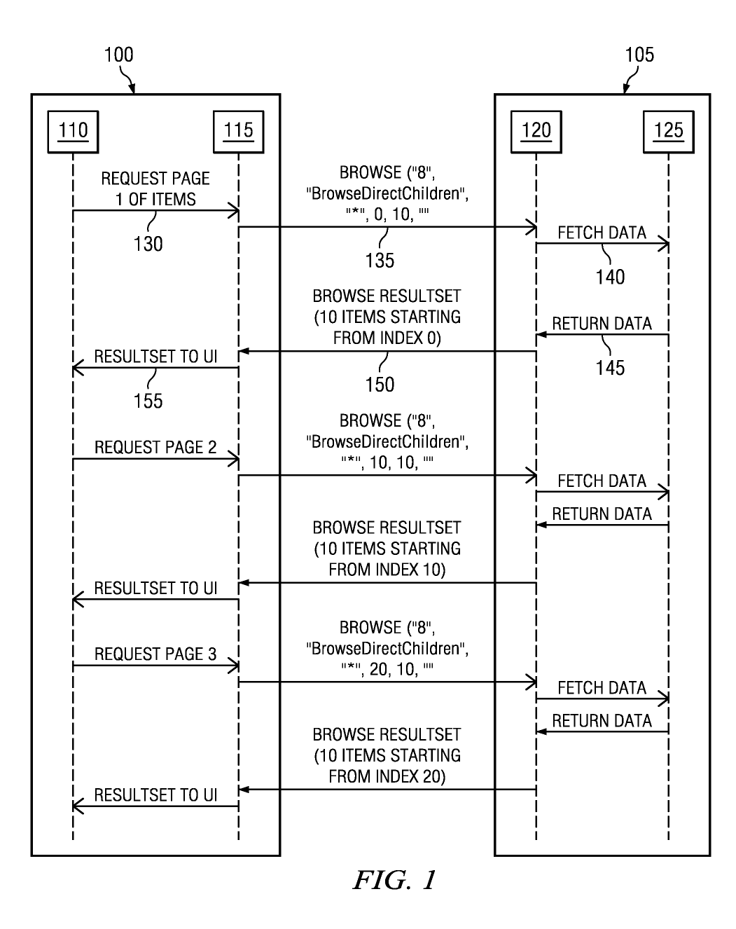

FIG. 1 is a message flow diagram depicting messages that are transmitted between a control point device 100 and a media server device 105 in a conventional browsing situation. As shown in FIG. 1, the control point device 100 includes a user interface 110 communicatively connected to a control point 115. The media server device includes a media server 120 communicatively connected to a database 125. The database 125 may include a variety of multimedia types including, for example, audio, video, graphics, digital photographs, and combinations thereof.

The process in FIG. 1 depicts a conventional browsing situation, where a user interface application is used to request content in small portions, in accordance with UPnP/DLNA specifications. Small data portions are used to keep the latency period short and to avoid network bursts. At 130 in FIG. 1, a request for a first page of items is sent from the user interface 110 to the control point 115. In response to this request, a “browse” message is sent from the control point 115 to the media server 120 at 135. In this particular situation, this message takes the form of: Browse (“8”, “BrowseDirectChildren”, “*”, 0, 10,″″. This indicates that the first 10 results of the “browse” request should be returned to the control point 115. In response to this message, an additional request message is sent from the media server 120 to the database 125 at 140. In an SQL-based implementation, this message may take the form of a SQL SELECT statement. The appropriate data is returned to the media server 120 at 145 as part of a “return data” message. At 150, the resultset is sent to the control point 115 as part of the message: Browse resultset (10 items starting from index 0). This means that the first ten results of the “browse” request are included. The result set is then provided to the user interface 105 at 155. The result set can then be exhibited to the user. The process is then repeated for subsequent pages of results, i.e., the next series of messages causes the next ten results to be provided to the user interface 110, followed by the next results, etc. This process continues until all of the desired pages of results have been delivered to the control point device 100 and have been provided to the user interface 110.

As can be observed in FIG. 1, the series of messages sent back and forth to and form the media server 120 becomes quite resource intensive. Therefore, various embodiments provide a system and method by which a media server's operations may be improved. In various embodiments, a new action parameter, for resource-intensive actions such as browse and CreateObject operations, is provided. This new parameter may be used as a “hint” by a control point to inform a device about a forthcoming action. This parameter allows the media server to optimize its operations, for example by increasing the priority of server processes, scheduling maintenance operations so that they occur at a later time, etc. Information related to the action may be provided by a control point which orders multimedia actions to occur in a home network.

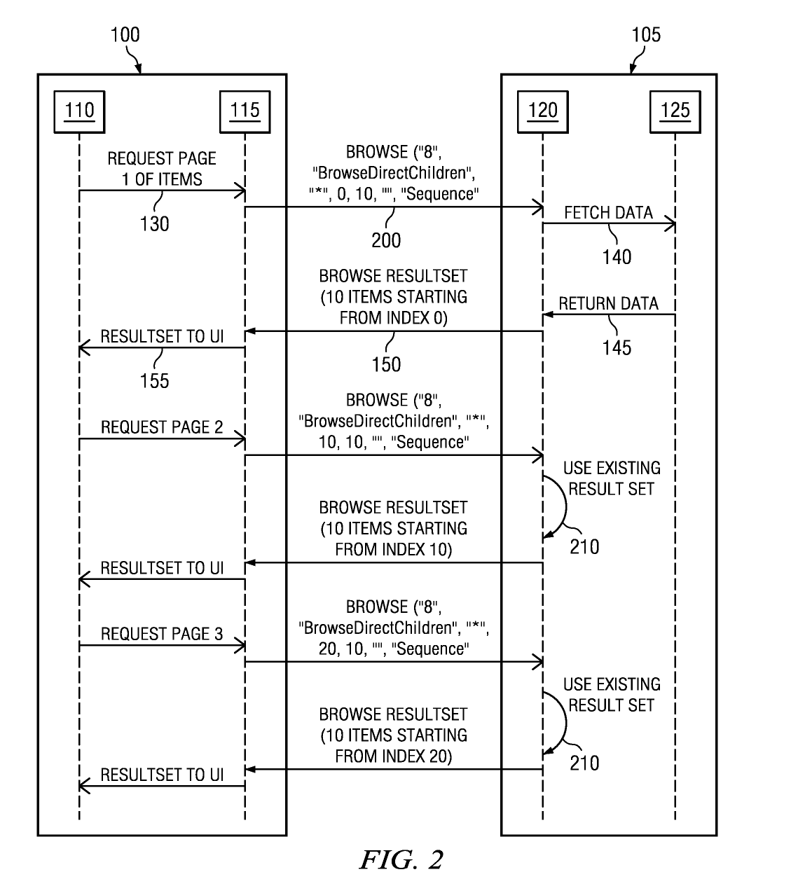

FIG. 2 is a message flow diagram depicting messages that are transmitted between the control point device 100 and the media server device 105 in a first use case scenario according to various embodiments. In various embodiments, the messages between the user interface 110 and the control point 115 are substantially identical to those depicted in FIG. 1. However, a new message is sent at 200 from the control point 115 to the media server 120. This message includes an indication that informs the media server 125 that a series or sequence of pages are going to be requested by the control point device 100.

In the embodiment depicted in FIG. 2, the message sent at 200 includes a “Sequence” identifier. The “Sequence” identifier indicates to the media server 120 that there will be several requests for information emanating from the control point 115, thereby consuming resources and processing power on the media server 120. When the media server 120 receives the message represented at 200 in FIG. 2, it knows that it will have to deliver multiple pages of information to the control point 115 in the future. Therefore, the media server 120 may, for example, obtain and store a larger set of search results than what is needed to response to the first request from the control point 115. For example, instead of retrieving one page of information at 140 and 145, the media server 120 may obtain five pages of information and store this information locally. As a result, when the control point 115 requests the second, third, fourth and fifth pages of information, the media server 120 simply needs to use the originally-retrieved and cached result set (represented at 210) in order to respond to the request. This eliminates the need for additional exchanges of requests and responses between the media server 125 and the database 130, thereby reducing the delay involved in providing the control point 115 with the subsequently requested pages. For example, when the media server 120 possesses SQL-based metadata storage, the efficiency ratio for constructing several smaller result sets may be significantly lower compared than the case where a larger result set is queried from the SQL database. At the same time, “other actions” which are to be undertaken by the media server can be delayed if so desired until a time when there are not likely to be other requests for information.

The precise manner in which the “Sequence” identifier may be used may vary. The variance may depend upon, for example, system settings, system preferences, and user instructions. As mentioned above, the media server 120 can make several decisions on its own in response to receiving such an identifier in a message. The decision-making process may be dependent upon a series of default settings, a set of preferences of the owner of the media server 120, or a combination of the two. Additionally, when such an identifier is received by the media server 120, it is possible for the owner of the media server 120 to be notified of information relating to this identifier. It should also be noted that, although the process depicted in FIG. 2 involves the use of a “Sequence” identifier, other types of indications may be provided to the media server 120 in various embodiments.

In addition to the above, it is also possible that an end user of the media server device 105 (such as where the media server device 105 is also the end user's own mobile telephone) may wish to initiate a massive performance critical share operation action of its own at the media server device 105. Such an operation may produce a great deal of new metadata. If the end user is aware that a long lasting sequential operation is about to commence, at the request of a control point 115, or is already in progress, he or she may decide to wait to start the operation until a later time. Alternatively, if the operation is considered to be very resource critical, then the media server device's software can prioritize or hide operations in the media server device's user interface while the already-initiated operation is ongoing. Other control points in the network can also obtain information about ongoing operation through the use of State variables. For example, such variables can indicate whether existing operations are or are not producing any events of ongoing operation, and indications may be provided to other users in the network at a given moment.

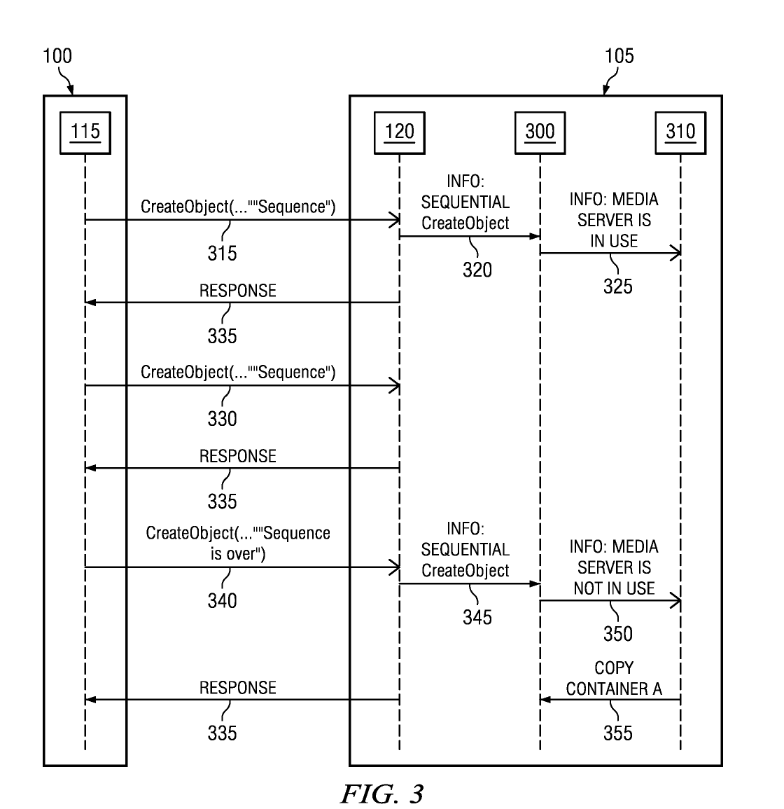

FIG. 3 is a message flow diagram depicting how an end user of the media server device 105 may be informed of a CreateObject operation according to various embodiments. As depicted in FIG. 3, the end user may be informed about the nature of the operation being conducted (at the request of the control point 115). If the end user of the media server device 105 wishes to perform its own resource-intensive actions, then it may be advisable for the end user to delay these actions until the other operations have been completed. At 315 in FIG. 3, the control point 115 transmits a “CreateObject” message that includes the “Sequence” identifier, indicating that multiple request and responses will be forthcoming between the control point 115 and the media server 120. It should be understood, however, that the “Sequence” identifier may be used in conjunction with a wide variety of messages emanating from the control point 115.

At 320, a message is relayed from the media server 120 to an application engine 300, with this message indicating that a sequential CreateObject action is taking place. At 325, the application engine informs the media server device's user interface 310 that the media server 120 is in use. In the event that the end user of the media server device 105 wishes to perform its own resource-intensive task, such as copying a large container file, for example, then it may decide to delay this procedure given the interactions between the control point device 100 and the media server 120. Alternatively, if the procedure is already underway, the end user may decide to temporarily pause this action.

Subsequent to 325, the control point device 100 and the media server device 105 will continue to exchange requests and responses. These messages are depicted at 330 and 335, respectively. The nature and timing of the messages may vary. As an example, the messages may take the form of the types depicted in FIGS. 1 and 2. Once the control point device 100 has received all of the information that it desires, it transmits a final message at 340. This message includes that no new requests will be forthcoming. In the embodiment depicted in FIG. 3, this information is transmitted via a “Sequence is Over” message. In response to this information, the media server 120 sends a new message to the application server 300 at 345. In response to this message. At 350, the application server 300 transmits to the user interface 310 information that the media server 120 is no longer in use. The end user may therefore decide to copy (or to resume copying) the container file at this point, since more resources will be available on the media server device 105. The end user therefore initiates or resumes this action at 355.

It should also be noted that, in the scenario depicted in FIG. 3, the behavior of the media server device 105 may also be implementation-specific. In particular, the actual operations of the media server device 105 may vary in some embodiments in the event that the operational flow between the various devices does not proceed as expected. For example, in the event that no “Sequence is over” message is received from the control point 115, but no new CreateObject-related messages are received over an extended period of time, it is possible for the media server 120 to “time out,” thereby resulting in a message to the user interface 310 that the CreateObject action is likely over. Other implementation-specific behavioral adjustments of the media server 120 are also possible.

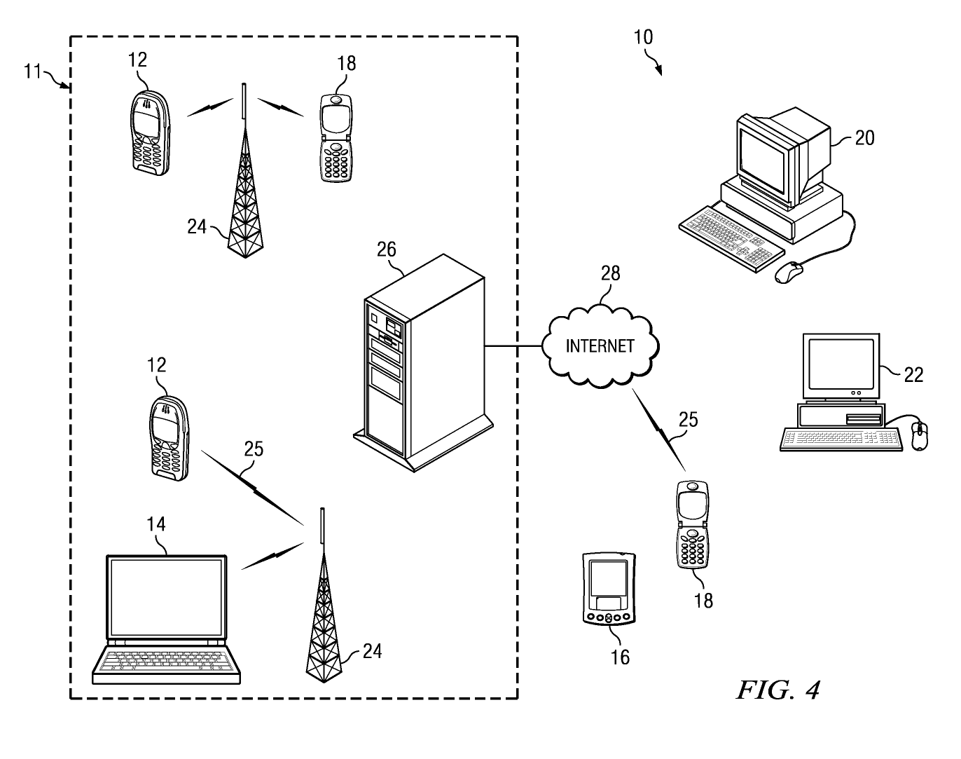

FIG. 4 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

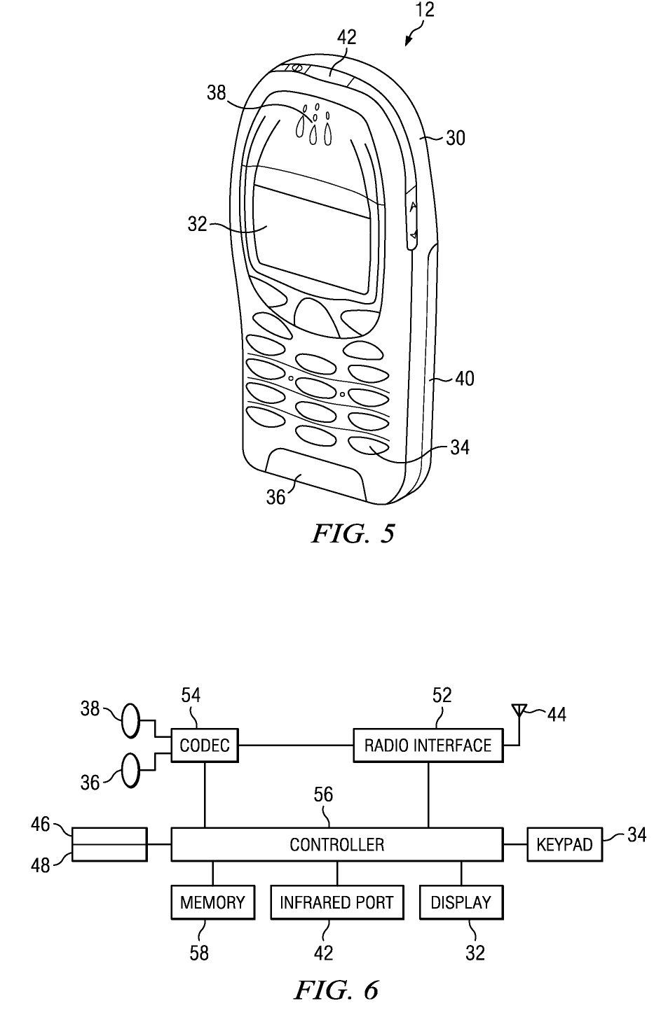

FIGS. 5 and 6 show one representative electronic device 12 within which the present invention may be implemented. It should be understood, however, that the present invention is not intended to be limited to one particular type of device. The electronic device 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving, at a server device, a message from a control point device concerning a request, the message including an indication that subsequent related requests will be made by the control point device;
taking at least one responsive action in response to the indication, the at least one responsive action related to improving resource utilization at the server device at least during a period in which the subsequent related requests are expected; and
providing a first set of results to the control point device in response to the request.

2. The method of claim 1, further comprising:
receiving a subsequent message from the control point device, the subsequent message indicating that no new related requests will be made by the control point device; and
providing information to a user of the server device, the information related to the subsequent message.

3. A computer program product, embodied in a computer-readable storage medium, comprising computer code configured to perform the processes of claim 1.

4. An apparatus, comprising:
a processor; and
a memory unit communicatively connected to the processor and including:
computer code configured to, at a server device, process a received message from a control point device concerning a request, the message including an indication that subsequent related requests will be made by the control point device;
computer code configured to take at least one responsive action in response to the indication, the at least one responsive action related to improving resource utilization at the server device at least during a period in which the subsequent related requests are expected;
computer code configured to provide a first set of results to the control point device in response to the request.

5. The apparatus of claim 4, wherein the at least one responsive action comprises obtaining from a database an enlarged set of results in response to the request, the enlarged set of search results being larger than first set of search results.

6. The apparatus of claim 4, wherein the at least one responsive action comprises providing information to a user of the server device that the server device is being used by another device.

7. The apparatus of claim 4, wherein the at least one responsive action comprises delaying the processing of at least one operation at the server device.

8. The apparatus of claim 4, wherein the server device comprises a media server device.

9. The apparatus of claim 4, wherein the memory unit further comprises:
computer code configured to process a received subsequent message from the control point device, the subsequent message indicating that no new related requests will be made by the control point device; and
computer code configured to provide information to a user of the server device, the information related to the subsequent message.

10. The apparatus of claim 4, wherein each request comprises at least one of a browsing request and a CreateObject request.

11. A method, comprising:
determining that a control point device desires to make a plurality of related requests directed to a server device;
in response to the determination, preparing a message concerning a first request, the message including an indication that subsequent related requests will be made; and
transmitting the message to a server device, whereby the indication is usable by the server device in taking at least one responsive action in response to the indication, the at least one responsive action related to improving resource utilization at the server device at least during a period in which the subsequent related requests are expected.

12. The method of claim 11, further comprising:
preparing a subsequent message for the server device, the subsequent message indicating that no new related requests will be made; and
transmitting the subsequent message to the server device, wherein the subsequent message is usable by the server device in providing information to a user of the server device, the information related to the subsequent message.

13. A computer program product, embodied in a computer-readable storage medium, comprising computer code configured to perform the processes of claim 11.

14. An apparatus, comprising:
a processor; and
a memory unit communicatively connected to the processor and including:
computer code configured to determine that a control point device desires to make a plurality of related requests directed to a server device;
computer code configured to, in response to the determination, prepare a message concerning a first request, the message including an indication that subsequent related requests will be made; and
computer code configured to transmit the message to a server device, whereby the indication is usable by the server device in taking at least one responsive action in response to the indication, the at least one responsive action related to improving resource utilization at the server device at least during a period in which the subsequent related requests are expected.

15. The apparatus of claim 14, wherein the at least one responsive action comprises obtaining from a database an enlarged set of results in response to the request, the enlarged set of search results being larger than first set of search results.

16. The apparatus of claim 14, wherein the at least one responsive action comprises providing information to a user of the server device that the server device is being used by another device.

17. The apparatus of claim 14, wherein the at least one responsive action comprises delaying the processing of at least one operation at the server device.

18. The apparatus of claim 14, wherein the server device comprises a media server device.

19. The apparatus of claim 14, wherein the memory unit further comprises:
computer code configured to prepare a subsequent message for the server device, the subsequent message indicating that no new related requests will be made; and
computer code configured to transmit the subsequent message to the server device,
wherein the subsequent message is usable by the server device in providing information to a user of the server device, the information related to the subsequent message.

20. The apparatus of claim 14, wherein each request comprises at least one of a browsing request and a CreateObject request.
